(19) United States
(12) Patent Application Publication
(10) Pub. No.: US 2026/0102024 A1
(43) Pub. Date: Apr. 16, 2026

(54) Blender Apparatus with Integrated Weight Scale

(71) Applicant: The NOCO Company, Glenwillow, OH (US)

(72) Inventors: Jonathan Lewis NOOK, Gates Mills, OH (US); James Richard STANFIELD, Glendale, AZ (US); James P. McBRIDE, Phoenix, AZ (US)

(21) Appl. No.: 19/356,275

(22) Filed: Oct. 13, 2025

Related U.S. Application Data
(60) Provisional application No. 63/707,391, filed on Oct. 15, 2024.

(51) Int. Cl. A47J 43/046; A47J 43/08; A47J 43/07

(52) U.S. Cl. CPC A47J 43/046; A47J 43/085; A47J 2043/0733

(57) ABSTRACT

Systems and methods are provided for a blender apparatus. The blender apparatus includes a blending container that is configured to contain food and/or liquids. The blender apparatus further includes a base unit coupled to the blending container. The base unit includes a weight scale, a controller, and a motor. The weight scale has one or more sensors that are configured to measure weight data based on the food and/or liquids within the blending container. The controller is coupled to the weight scale and is configured to receive the weight data. The motor is coupled to the controller and is configured to set or adjust a speed of the motor based on the weight data. The one or more sensors may be further configured to measure a load on the motor and the controller may be further configured to change the speed of the motor based on the load on the motor.

### CROSS-REFERENCE TO RELATED APPLICATION

This application claims priority to U.S. Provisional Application No. 63/707,391, filed on October 15, 2024, the entirety of which is incorporated herein by reference.

### FIELD

The present disclosure relates to electric blenders, and more specifically to electric blenders having an integrated weight scale.

### BACKGROUND

Blenders are often used to mix, puree, and emulsify food and beverages. Some blenders lack the ability to precisely measure the weight of ingredients within a blending container of the blender directly. Moreover, some blenders are unable to adjust the speed of a motor within the blender based on factors such as the weight of the ingredients within the blending container and the load on the motor during operation. Users of such blenders may require a separate kitchen scale to measure the ingredients prior to placing them in the blending container. Additionally, users of such blenders may be required to continually adjust settings (e.g., blade speed) of the blender manually to properly process the food or beverages according to their preferences. This operation can be time-consuming and inconvenient, especially when preparing recipes that require specific ingredient quantities. It may be advantageous to provide a blender that is capable to weighing contents within a blending container and adjusting settings of the blender based on weight data.

### SUMMARY

Systems and methods are provided for a blender apparatus. The blender apparatus comprises a blending container that is configured to contain food and/or liquids. The blender apparatus further includes a base unit coupled to the blending container. The base unit includes a weight scale, a controller, and a motor. The weight scale has one or more sensors that are configured to measure weight data based on the food and/or liquids within the blending container. The controller is coupled to the weight scale and is configured to receive the weight data. The motor is coupled to the controller and is configured to set or adjust a speed of the motor based on the weight data. The one or more sensors may be further configured to measure a load on the motor and the controller may be further configured to change the speed of the motor based on the load on the motor.

In another example, a method of preparing food includes containing the food in a blending container. Weight data is measured based on a weight of the food with one or more sensors. The method further includes blending the food with a blade connected to the motor. A speed of the motor is based at least in part on the weight data. A load on the motor may also be measured, and the speed of the motor may be changed based on the load of the motor.

In another example, a blender apparatus includes a blending container configured to contain food and/or liquids, and a base unit coupled to the blending container, where the base unit includes a controller and a motor. The controller may be configured to receive signals from one or more sensors to determine a weight of food and/or liquids within the blending container and a load on the motor during operation of the blender apparatus. The controller may be further configured to set and/or adjust a speed of the motor based on the weight and/or the load. In embodiments, the controller may be configured to set an initial speed of the motor based at least in part of the weight and/or to dynamically adjust the speed of the motor during operation based on the load on the motor.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1 depicts a block diagram of a blender apparatus, in accordance with some embodiments.

FIG. 2 depicts a data flow diagram of a blender apparatus, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention.

As described above, some blenders may lack the ability to precisely measure the weight of ingredients within a blending container of the blender directly. Furthermore, some blenders lack the ability to adjust settings of the blender based on factors such weight measurements and the load on the motor during operation. Users of such blenders may require a separate kitchen scale to measure the ingredients prior to placing them in the blending container. This can be time-consuming and inconvenient, especially when preparing recipes that require specific ingredient quantities. An integrated weight scale within a blender may streamline the process of preparing food and beverages, for example, by eliminating the need for a separate scale and allowing users to weight ingredients directly within the blending container.

Systems and methods disclosed herein include a blender apparatus with an integrated weight scale. The weight scale may be built (e.g., integrated) into a base of the blender and may provide real-time weight measurements of the contents of the blending container. Information based on the weight measurements may be displayed on an integrated display of the blender, which may show measurements in various units (e.g., grams, ounces, pounds). The blender may include several operational modes, such as start/stop, variable speed control, preset blending modes, and a self-cleaning feature. The blender apparatus may be designed to accommodate multiple interchangeable attachments for various blending and mixing functions, making the blender apparatus highly versatile.

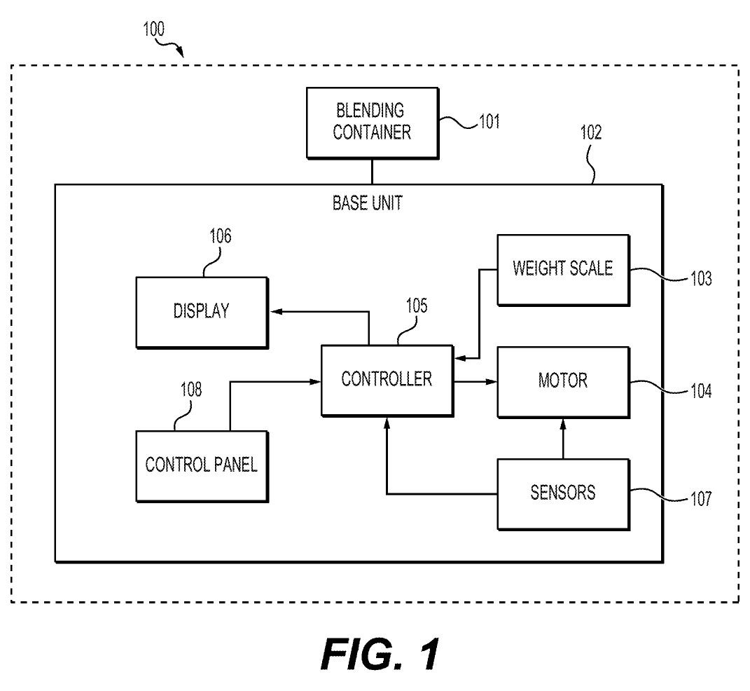

FIG. 1 depicts a blender apparatus, in accordance with some embodiments. In the example shown in FIG. 1, the blender apparatus 100 includes a blending container 101. The blending container 101 may be configured to contain various ingredients during operation of the blender apparatus 100. The blending container 101 is attached to or attachable to a base unit 102. The base unit 102 may include a housing and may be configured to rest upon a surface (e.g., counter) during operation of the blender apparatus 100. The base unit 102 may include a weight scale 103 that is configured to measure the weight of the contents of the blending container 101. The weight scale 103 is coupled to a controller 105.

The base unit 102 further includes a motor 104 that is coupled to the controller 105. The motor 104 may be configured to receive control signals from the controller 105 based on data from the weight scale 103 and adjust a speed of the motor 104, as described further below. The base unit 102 further includes one or more sensors 107 that are coupled to the motor 104 and the controller 105. In some examples, the one or more sensors 107 are included within the weight scale 103. The sensors 107 are configured to detect the weight of the contents of the blending container 101. The sensors 107 may be further configured to detect a load on the motor 104 during operation of the blender apparatus 100.

The base unit 102 further includes a control panel 108 coupled to the controller 105. The control panel 108 is configured to receive input from a user of the blender apparatus 100. For example, the user may select a control (e.g., button) on the control panel 108 that indicates an increase in the speed of the motor 104. Based on the input, the control panel 108 may signal to the controller 105 to increase the speed of the motor 104. The control panel 108 may also include various controls for selecting or programming preset blending modes, display options (e.g., toggling between weight units to display on the display 106), powering on and off the blender apparatus 100, and starting and stopping an operation of the blender apparatus 100.

Based on data from the motor 104, the sensors 107, and input from a control panel 108, the controller 105 may be configured to control (e.g., adjust) the speed of the motor 104. The base unit 102 further includes a display 106. The display 106 is configured to display data from the weight scale (e.g., the weight of the contents of the blending container 101). Additional connections (e.g., couplings) between the weight scale 103, motor 104, controller 105, display 106, sensors 107, and control panel 108 may be present that are not depicted in the example shown in FIG. 1.

As described above, the blender apparatus 100 may comprise a base unit 102, a blending container 101, an integrated weight scale 103, a digital display 106, a control panel 108, and various attachments. The weight scale 103 may be positioned within the base unit 102 beneath the blending container 101, which may allow for accurate measurements of the contents of the blending container 101 when the blending container 101 is placed on the base unit 102. The base unit 102 may include a motor 104 (e.g., an electric, brushless motor). The blender apparatus 100 may further include a blade attachment mechanism that may be attachable to the motor 104 via the base unit 102. The blade may be precision balanced.

The integrated weight scale 103 may include one or more sensors 107 embedded within the base unit 102 that can detect the weight of the blending container 101 and its contents. These sensors 107 can communicate with a controller 105 (e.g., microcontroller) that processes the weight data and displays the weight data on a screen (e.g., digital screen) of the integrated display 106. As described above, the display can display the weight data in various units, and may include an option to toggle between units (e.g., between grams and ounces) via the control panel 108. For example, a user may press a button on the control panel 108, and based on the pressing of the button, the control panel 108 may communicate to the controller 105 to toggle the units displayed on the display 106. Moreover, the blender apparatus 100 may include a tare function, which can allow users to reset the displayed weight to zero, thereby enabling the addition and weight measurement of multiple ingredients without manual weight calculations. The tare function may also be configured to subtract the weight of the empty blending container 101.

Furthermore, the sensors 107 within the base unit 102 may allow for dynamic speed adjustment. For example, the sensors 107 may be coupled to the motor 104 and configured to adjust the speed of the motor 104 based on the weight of the blending container 101 and its contents. The sensors 107 may also be configured to detect the load on the motor 104 and may dynamically adjust the speed of the motor 104 based on the load on the motor 104. For example, the sensors 107 may be configured to increase a speed of the motor 104 (and thus a speed of the blade) based on a greater weight of the blending container 101 and its contents or a greater load on the motor 104. Alternatively, the sensors 107 may be configured to decrease the speed of the motor 104 based on a lesser weight of the blending container 101 and its contents or a lesser load on the motor 104.

During operation of the blending apparatus 100, the load on the motor 104 may change. For example, the contents of the blending container 101 may change viscosity (e.g., become less viscous) as the blade blends the contents. Based on the change in the load on the motor 104, the sensors 107 may dynamically adjust the speed of the motor 104 during operation. In one example, the speed of the motor 104 may be initially adjusted based on the weight of the blending container 101 and its contents, and then dynamically adjusted during operation based on change(s) in the load on the motor 104.

The display 106 may be mounted on a front face of the base unit 102, and can provide clear visibility of weight measurements and blending settings. The control panel 108 may include a plurality of buttons that can be used for power, to start and stop operation of the blender apparatus 100, for variable speed control, and for preset blending modes (e.g., smoothie, pulse, chop). A self-cleaning mode may be activated via the control panel 108, which may operate the motor 104 at a pre-determined speed (e.g., a high speed) with a small amount of water and detergent (added by the user), effectively cleaning the blending container 101.

The base unit 102 may include one or more features designed to minimize the sound generated by the base unit 102 (e.g., due to the motor 104). For example, the motor 104 within the base unit 102 may include advanced motor control and pulse-width modulation (PWM) frequency control. Moreover, the motor 104 may include an aerodynamic design to reduce noise. Furthermore, the base unit 102 may include vibration isolation, a weighted base design, and acoustical insulation. In embodiments, sound may be further minimized using one or more of an exhaust air flow path designed to promote laminar flow, cancelation of sound waves, and/or altering sound to a more pleasant pitch, the inclusion of a vent flow path in the blending container 101, a blending container 101 with a double wall that isolates vibration and/or provides acoustic insulation, a blender container 101 lid assembly that isolates vibration and/or provides acoustic insulation, a motor to blender torque coupler (e.g., spline or similar) designed for minimal mechanical noise, or the use of a brushless DC motor (BLDC) which runs much quieter than a brushed motor.

The base unit 102 may also include one or more features designed to cool the base unit 102, which can increase safety and provide for use of the blender apparatus 100 for extended periods of time. For example, the base unit 102 may include a fan which has an optimum design. The base unit 102 may also utilize passive cooling to dissipate heat generated by the base unit 102.

The blender apparatus 100 may include variable speed control. The variable speed control may allow users to adjust a blending speed (e.g., via the control panel 108). The variable speed control may range from a low speed to a high speed. For example, the variable speed may be adjusted by the user based on a desired consistency of food within the blending container 101. Furthermore, the blender apparatus 100 may include one or more preset modes. The preset modes may be pre-programmed or may be programmable by the user. For example, the user may use the control panel 108 to program one or more preset modes for common recipes, which may include a specified blending speed and duration, or a series of consecutive blending steps, each of which includes a specified blending speed and duration.

The blender apparatus 100 may also include a plurality of various attachments, such as a grinding blade, a whisk, or a dough hook. The attachments may be secured using a locking mechanism on the base unit, which may ensure safety and stability during operation.

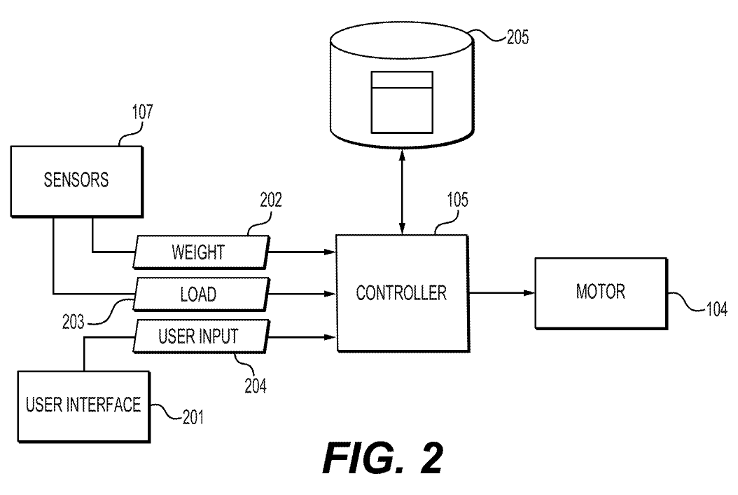

FIG. 2 depicts a data flow diagram of a blender apparatus, in accordance with some embodiments. As shown in FIG. 2, the controller 105 may be configured to receive data. For example, the controller 105 may receive weight data 202 concerning a weight of food within the blending container of the blender apparatus 100 (FIG. 1). Furthermore, the controller 105 may be configured to receive load data 203 of a load on the motor 104. The weight data 202 and the load data 203 may be received from one or more sensors 107. Furthermore, the controller 105 may be configured to receive user input data 204 from a user interface 201. In some examples, the user interface 201 is the control panel 108 depicted in FIG. 1. As described above, the user input data 204 may include an indication to increase or decrease a speed of the motor 104.

As shown in FIG. 2, the controller 105 may further be coupled to a database 205. The database 205 may be included in, for example, a non-transitory computer-readable medium that is included within the blender apparatus 100 (FIG. 1). The database 205 may store one or more algorithms and/or data (e.g., a lookup table (LUT)) that is used by the controller 105 to modify control of the motor 104. For example, the controller 105 may determine (e.g., via an algorithm and/or LUT) a speed of the motor 104 corresponding to weight data 202 and/or load data 203 received by the controller 105. Based on the speed of the motor 104 that the controller 105 determines is appropriate, the controller 105 may adjust the power delivered to the motor 104, thereby modifying its speed.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A blender apparatus comprising:
a blending container configured to contain food and/or liquids; and
a base unit coupled to the blending container, the base unit including:
a weight scale having one or more sensors that are configured to measure weight data based on the food and/or liquids within the blending container;
a controller coupled to the weight scale, the controller configured to receive the weight data; and
a motor coupled to the controller, the controller configured to set or adjust a speed of the motor based on the weight data.

2. The blender apparatus of claim 1, wherein the one or more sensors are further configured to measure a load on the motor and the controller is further configured to change the speed of the motor based on the load on the motor.

3. The blender apparatus of claim 1, further comprising a control panel coupled to the controller, the control panel configured to receive input from a user and the controller configured to change the speed of the motor based on the input.

4. The blender apparatus of claim 1, further comprising a display coupled to the weight scale and configured to receive the weight data and display information based on the weight data.

5. The blender apparatus of claim 1, wherein the base unit includes acoustical insulation.

6. The blender apparatus of claim 1, further comprising a fan configured to cool the base unit.

7. The blender apparatus of claim 1, wherein the motor is a brushless electric motor.

8. The blender apparatus of claim 1, the blender apparatus further configured to operate in a self-cleaning mode to clean the blending container, wherein the motor operates at a predetermined speed when the blender apparatus is in self-cleaning mode.

9. The blender apparatus of claim 1, the base unit further comprising a locking mechanism configured to secure one or more attachments to the base unit.

10. A method of preparing food comprising:
containing the food in a blending container;
measuring weight data based on a weight of the food with one or more sensors; and
blending the food with a blade connected to a motor, a speed of the motor based at least in part on the weight data.

11. The method of claim 10, further comprising measuring a load on the motor and changing the speed of the motor based on the load of the motor.

12. The method of claim 10, further comprising receiving input from a user and changing the speed of the motor based on the input.

13. The method of claim 10, further comprising displaying information on a display based on the weight data.

14. The method of claim 10, wherein the base unit is acoustically insulated.

15. The method of claim 10, further comprising cooling the base unit.

16. The method of claim 10, wherein the motor is a brushless electric motor.

17. The method of claim 10, further entering a self-cleaning mode in response to a user input, and operating the motor at a predetermined speed while in self-cleaning mode to clean the blending container.

18. A blender apparatus comprising:
a blending container configured to contain food and/or liquids; and
a base unit coupled to the blending container, the base unit including:
a controller configured to receive signals from one or more sensors to determine a weight of food and/or liquids within the blending container and a load on the motor during operation of the blender apparatus, and
a motor coupled to the controller, the controller configured to set and/or adjust a speed of the motor based on the weight and/or the load.

19. The blender apparatus of claim 18, wherein the controller is configured to set an initial speed of the motor based at least in part of the weight.

20. The blender apparatus of claim 18, wherein the controller is configured to dynamically adjust the speed of the motor during operation based on the load on the motor.
